(19) United States
(12) Patent Application Publication
(10) Pub. No.: US 2013/0231442 A1
(43) Pub. Date: Sep. 5, 2013

(54) THERMALLY STABLE POLYESTER (ALKYD) POLYMERS

(71) Applicant: REICHHOLD, INC., Research Triangle Park, NC (US)

(72) Inventor: Robert S. DeRuiter, Cary, NC (US)

(73) Assignee: Reichhold, Inc., Research Triangle Park, NC (US)

(21) Appl. No.: 13/775,681

(22) Filed: Feb. 25, 2013

Related U.S. Application Data
(60) Provisional application No. 61/605,412, filed on Mar. 1, 2012.

(51) Int. Cl. C09J 167/00

(52) U.S. Cl. CPC C09J 167/00
USPC 525/56; 525/418; 525/186

(57) ABSTRACT

A polyester (alkyd) for use in hot melt adhesive composition is provided. Unreacted carboxyl groups in the alkyd resin are reacted with a monofunctional epoxide to form functional groups that are unreactive with alcohols.

### CROSS REFERENCE TO RELATED APPLICATIONS

This application claims priority to U.S. Provisional Application Ser. No. 61/605,412, filed Mar. 1, 2012, the disclosure of which is incorporated herein by reference in its entirety.

### FIELD AND BACKGROUND OF THE INVENTION

The present invention relates to alkyd resins and their use in a hot melt adhesive. Hot melt adhesives are used in a wide variety of industries. In general, hot melt adhesives are heated to provide a liquid or flowable composition and after application and cooling is a solid. Because the hot melt adhesive must be flowable, high temperature viscosity stability is important. Various polymer systems have been used and include the use of one or more polymer such as ethylene-vinyl acetate copolymers polypropylene, styrene-butadiene copolymers, polyesters, polyamides, and polyurethanes. While such polymer systems have the desired thermal stability, adhesion performance, water stability, aesthetics and the like, these systems often use raw materials that are petrochemically derived and contain not renewable components.

In use, hot melt adhesives require that the adhesive component be melted in a heated reservoir. Typically the temperature in the reservoir is from 120° C. to 140° C. Although the desired intent is to keep residence time in the reservoir to a minimum, maintenance or down time frequently results in the adhesive material being held in the above temperature range for an extended time. The adhesive material exposed to such an extended period, however, must still be usable. One test for this is viscosity stability and the standard is 72 hours at 130° C. with a viscosity increase of 25 to 35 percent being acceptable. Existing polyester (alkyd) hot melt adhesive compositions experience viscosity increases of 80 percent or more. Thus, such hot melt adhesives are unsuitable for continued use.

Therefore it would be desirable to utilize polyester (alkyds) having improved viscosity stability to provide high temperature stability to various hot melt adhesive compositions.

### SUMMARY OF THE INVENTION

To this end, a polyester (alkyd) suitable for use in hot melt adhesives is provided. Such a polyester (alkyd) has improved viscosity stability at elevated temperatures for extended periods of time. The polyester (alkyd) includes unreacted carboxyl groups in the alkyd that have been reacted with at least one monofunctional epoxide to form functional groups that are unreactive with alcohols. By reacting the residual carboxyls in this matter, the hydroxyls of any alcohols will have nothing to which to react. Stated otherwise, the residual carboxyls are “scavenged” with the monofuntional epoxide to form the unreactive functional groups, and continued esterification can no longer occur. A hot melt adhesive incorporating the polyester (alkyd) of the invention is also provided.

### DETAILED DESCRIPTION OF EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Furthermore, any patent reference cited herein is hereby incorporated by reference in its entirety.

The present invention provides a hot melt adhesive comprising a polyester (alkyd) wherein unreacted carboxyl groups in the alkyd resin have been reacted with at least one monofunctional epoxy component to form one or more functional groups that are unreactive with alcohols. By scavenging the unreacted carboxyl groups in this matter, high temperature stability of the alkyd can be achieved thereby making such an alkyd suitable for use in a hot melt adhesive.

As discussed above, industrial applications of polyester (alkyds) require that the hot melt adhesive compounds be melted in a reservoir prior to being applied to a substrate. Temperatures in the range of 120° C. to 140° C. are typical and often the adhesive is held at such a temperature for extended periods, i.e., up to 72 hours After the extended period, the adhesive must still be useable and the viscosity should be at a level so that the adhesive compound still flows acceptably. A conventional alkyd resin when incorporated into a hot melt adhesive composition will typically have an unacceptable viscosity increase of 80 percent or higher.

The term “polyester (alkyd)” refers to a polymer that includes a polyester derived from the reaction of an alcohol and an acid or an acid anhydride. In some embodiments, the polyester (alkyd) includes an alkyd that is derived from at least one anhydride and at least one polyol, and is modified/reacted with a natural oil, synthetic oil, and/or an unsaturated fatty acid.

The acid and/or acid anhydride portion of the alkyd may be any diacid or monofunctional acid known in the art used in the formation of an alkyd resin. The dicarboxylic acid may be, for example, isophthalic acid, phthalic anhydride(acid), terephthalic acid, adipic acid, tetrachlorophthalic anhydride, dodecanedioic acid, sebacic acid, azelaic acid, 1,4-cyclohexanedicarboxylic acid, 1,3-cyclohexanedicarboxylic acid, maleic anhydride, fumaric acid, succinic anhydride, succinic acid, 2,6-naphthalenedicarboxylic acid, or glutaric acid and the like. In one embodiment, the dicarboxylic acid is isophthalic acid, phthalic anhydride, or phthalic acid. A monofunctional acid may also be used such as, for example, benzoic acid, acetic acid, propionic acid, and butanoic acid.

The polyhydric alcohol comprise alcohols having multiple hydroxyl groups per molecule including dihydric alcohols such as ethylene glycol, 1,2-propylene glycol, 2,3-butylene glycol, 1,4-butanediol, 1,5-pentanediol and 2,2-bis(4-hydroxycyclohexyl) propane; trihydric alcohols such as glycerine, 1,1,1-trimethylolethane, 1,1,1-trimethylolpropane, and 1,2,6-hexanetriol; tetrahydic alcohols such as erythritol, pentaerythritol and alpha-methyl glucoside; pentahydric and hexahydric alcohols such as tetramethylolcyclohexanol, dipentaerythritol, mannitol and sorbitol; polyallyl alcohol; and oxyalkylene adducts such as diethylene glycol, triethylene glycol and polyethylene glycol.

The polyester (alkyd) may be modified with a natural oil. The term “natural oil” refers to a triglyceride derived from a renewable resource, such as plant material. Exemplary natural oils include soy oil, corn oil, rapeseed oil, flax oil, castor oil, sunflower oil, fish oil, tung oil, linseed oil, palm kernel oil, palm seed oil, cottonseed oil, canola oil, dehydrated castor oil, safflower oil, oticica oil, beef tallow oil, coconut oil, and the like, and blends thereof. Suitable fatty acids are often C₁₀ to C₂₂ saturated and unsaturated fatty acids and include oleic acid, capric acid, caproic acid, linoleic acid, linolenic acid, recinoleic acid, lauric acid, myristic acid, stearic acid, palmitic acid, eicosanoic acid, eleostearic acid, and the like. In one embodiment, hydrogenated oils and fatty acids are used to minimize unsaturation. Combinations and mixtures of natural oils and/or synthetic oil and fatty acids may be used,

Suitable monofunctional epoxies for scavenging the residual carboxyls include C₁₀-C₁₆ alkyd glycidyl ethers, glycidyl acrylate, glycidyl methacrylate, ethylene oxide, propylene oxide, propylene carbonate, and glycidyl neodecanoate. In one embodiment, the monofunction epoxy is glycidal neodecanoate available as Cardura E10 from Shell,

In operation, the polyester (alkyd) polymers are formulated with a hydroxyl excess which provides alkyd polymers with low residual carboxyl content as measured by acid value (mgKOH per gram of polymer). The present invention provides a low acid value of less than 3 by reacting substantially all of the residual carboxyls with the monofunctional epoxide to form functional groups that are unreactive with alcohols. This facilitates control of viscosity.

Hot melt adhesive compositions into which the polyester (alkyd) are incorporated may include, in addition to the alkyd, polymers which provide cohesive strength. Exemplary polymers and copolymers include ethylene-vinyl acetate, ethylene acrylate copolymers, styrene-butadiene, ethylene-ethyl acrylate, low density polypropylene, polyamides, other polyesters, polyurethanes, polyvinyl alcohols, polylactic acid, and blends thereof.

The adhesive composition may include one or more additional components, i.e., additives to enhance various characteristics of the hot melt adhesive and/or the processability thereof. Such additives may include tackifiers (e.g., rosins and rosin esters), waxes, mineral oils, paraffin oils, antioxidants, plasticizers such as those based on the natural oils discussed previously, inorganic fillers such as calcium carbonate, aluminum hydroxide, calcium hydroxide, magnesium hydroxide, talc, clay, mica and wollastonite; powders, fibers or flakes of metals such as copper, iron, cobalt, nickel, chromium, aluminum and manganese, or their alloys; powders, fibers or flakes of copper oxide, iron oxide, lead oxide and so on; organic metal compound pigments such as copper phthalocyanine (phthalocyanine blue); inorganic pigments such as chrome yellow, mineral violet, carbon black, iron oxide, ultramarine, cobalt blue, cobalt violet and titan white; flame retardants, ultraviolet absorvers, and stabilizers.

A typical hot melt adhesive composition may include 10 to 40 percent by weight of the polymers providing cohesive strength, 50 to 80 percent by weight of the polyester (alkyd), and 0 to 35 percent by weight of the additives.

The hot melt adhesive may be formed by mixing using conventional techniques such as blending, kneading, using a Henschel mixer and then extruding into a molded article. Exemplary molded articles may include plates, pellets, sheets, films, and the like.

In general, the hot melt adhesive is used to bond one or more substrates together. Bonding conditions during use of the hot melt adhesive vary depending on the end use. In one embodiment, the hot melt adhesive composition is applied to a substrate at temperatures of from about 90° C. to about 120° C. and cured at a temperature of about 120° C. to about 200° C.

Exemplary end uses include baby care articles including diapers, wipes, bed mats, etc., paper products, feminine protection, incontinence care, such as described in U.S. application Ser. No. 12/463,659, the disclosure of which is incorporated by reference in its entirety, laminated substrates (e.g., wood panels), packaging (e.g., corrugated boxes), carpeting, woven and non-woven fabrics, glue sticks, tapes, and the like.

The present invention will now be described in more detail with reference to the following examples. However, these examples are given for the purpose of illustration and are not to be construed as limiting the scope of the invention.

### EXAMPLES

The alkyds are formulated and prepared via conventional techniques. After processing to the desired molecular weight/viscosity, the alkyd resin portion was cooled to approximately 180° C. after which a stoichiometric amount of monofunctional reactant (Cardura E10) was added and reacted to the target low acid value. High temperature stability testing of the resultant polymers (72 hours at 130° C.) showed no viscosity advance for final acid values less than 2, and minimal viscosity advance for final acid values between 2 and 3.

### Example 1

A polyester (alkyd) was prepared using the following formulation and procedure:

| | |
|---|---|
| Coconut oil | 900 gms |
| Pentaerythritol | 373 gms |
| Phthalic anhydride | 598 gms |

The oil and polyol were transesterified at 240° C. using standard alcoholysis catalyst, cooled, diacid added, heated to esterification temperature, held for target viscosity and acid value, cooled and transferred to quart cans for storage. Final resin properties and high temperature stability results are in Table 1.

### Example 2

A polyester (alkyd) was prepared as in Example 1, after reaching target viscosity and acid value the resin was cooled to 180° C., glycidyl neodecanoate was added and reacted to achieve 1.0 maximium acid value, the resin was then cooled and transferred to quart cans for storage. Final properties and high temperature stability results are in Table 1.

### Example 3

A polyester (alkyd) was prepared as in Example 1, after reaching target viscosity and acid value the resin was cooled to 180° C., glycidyl neodecanoate was added and reacted to achieve approx. 2.0 acid value, the resin was then cooled and transferred to quart cans for storage. Final properties and high temperature stability results are in Table 1.

### Example 4

A polyester (alkyd) was prepared as in Example 1, after reaching target viscosity and acid value the resin was cooled to 180° C., glycidyl neodecanoate was added and reacted to achieve approximately 2.5 acid value, the resin was then cooled and transferred to quart cans for storage. Final properties and high temperature stability results are in Table 1.

### Example 5

A polyester (alkyd) was prepared as in Example 1, after reaching target viscosity and acid value the resin was cooled to 180° C., glycidyl neodecanoate was added and reacted to achieve approximately 3.0 acid value, the resin was then cooled and transferred to quart cans for storage. Final properties and high temperature stability results are in Table 1.

### Example 6

A polyester (alkyd) was prepared using the following formulation and procedure:

| | |
|---|---|
| Stearic acid | 842 gms |
| Glycerine | 189 gms |
| Pentaerythritol | 218 gms |
| Phthalic anhydride | 516 gms |

The reactants were esterified at 230° C., held for target viscosity and acid value, cooled to 180° C., glycidyl neodecanoate was added and reacted to achieve <2.0 acid value, the resin was then cooled and transferred to quart cans for storage. Final properties and high temperature stability results are in Table 1,

### Example 7

A polyester (alkyd) was prepared using the following formulation and procedure:

| | |
|---|---|
| Stearic acid | 501 gms |
| Glycerine | 504 gms |
| Benzoic acid | 88 gms |
| Phthalic anhydride | 705 gms |

The reactants were esterified at 230° C., held for target viscosity and acid value, cooled to 180° C., glycidyl neodecanoate was added and reacted to achieve <2.0 acid value, the resin was then cooled and transferred to quart cans for storage. Final properties and high temperature stability results are in Table 1.

TABLE 1
Resin Properties

| | Example 1 | Example 2 | Example 3 | Example 4 | Example 5 | Example 6 | Example 7 |
|---|---|---|---|---|---|---|---|
| ¹Viscosity | 28.8 | 28.8 | 30.7 | 34.5 | 36.7 | 25.8 | 81.0 |
| 120° C. | | | | | | | |
| ¹AV | 8.3 | 1.0 | 2.0 | 2.4 | 2.9 | 1.5 | 1.4 |
| ²Viscosity | 41.2 | 28.8 | 29.6 | 35.6 | 39.3 | 24.1 | 76.5 |
| 120° C. | | | | | | | |
| ²AV | 7.6 | 0.9 | 2.0 | 2.4 | 3.0 | 1.5 | 1.9 |
| % | 43.1 | 0 | −3.6 | 3.2 | 7.1 | −6.6 | −5.6 |
| Viscosity | | | | | | | |
| Increase | | | | | | | |

Hot melt adhesive compounds formulated from the polyester (alkyd) prepared using this invention were found to be suitably stable for industrial use.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

That which is claimed:

1. A polyester (alkyd) for use in hot melt adhesives wherein unreacted carboxyl groups in the alkyd have been reacted with at least one monofunctional epoxide to form one or more functional groups that are unreactive with alcohols.

2. The polyester (alkyd) of claim 1, wherein the alkyd has an acid value of 3.0 or less.

3. The polyester (alkyd) of claim 1, wherein the hot melt adhesive has a viscosity increase of less than 25% after 72 hours at 130° C.

4. The polyester (alkyd) of claim 1, wherein the at least one monofunctional epoxide comprises glycidyl neodecanoate,

5. A process for heat stabilizing a hot melt adhesive that comprises a polyester (alkyd), wherein the process comprises reacting unreacted carboxyl groups in the alkyd with at least one monofunctional epoxide.

6. The process of claim 5, wherein after the unreacted carboxyl groups have reacted with the at least one monofunctional epoxide, the acid value of the polyester (alkyd) is 3.0 or less.

7. The process of claim 5, wherein after the unreacted carboxyl groups have reacted with the at least one monofunctional epoxide, the polyester (alkyd) is thermally stable such that the viscosity increase of the alkyd after 72 hours at 130° C. is less than 25%.

8. The process of claim 5, wherein the at least one monofunctional epoxide comprises glycidyl neodecanoate.

9. A hot melt adhesive composition comprising 10 to 40 percent by weight of a polymer or copolymer to provide cohesive strength, 50 to 80 percent by weight of a polyester (alkyd) wherein unreacted carboxyl groups in the alkyd have been reacted with at least one monofunctional epoxide to form one or more functional groups that are unreactive with alcohols.

10. The hot melt adhesive composition of claim 9, wherein the alkyd has an acid value of 3.0 or less.

11. The hot melt adhesive composition of claim 9, wherein the hot melt adhesive has a viscosity increase of less than 25% after 72 hours at 130° C.

12. The hot melt adhesive composition of claim 9, wherein the at least one monofunctional epoxide comprises glycidyl neodecanoate.

13. The hot melt adhesive composition of claim 9 wherein the polymer or copolymer to provide cohesive strength is selected from the group consisting of ethylene-vinyl acetate, ethylene acrylate copolymers, styrene-butadiene, ethylene-ethyl acrylate, low density polypropylene, polyamides, other polyesters, polyurethanes, polyvinyl alcohols, polylactic acid, and blends thereof.
